(19) United States
(12) Patent Application Publication
(10) Pub. No.: US 2018/0253751 A1
(43) Pub. Date: Sep. 6, 2018

(54) USER EQUIPMENT, SERVICE PROVIDING APPARATUS, POS TERMINAL, PAYMENT SYSTEM INCLUDING THE SAME, CONTROL METHOD THEREOF, AND NON-TRANSITORY COMPUTER READABLE STORAGE MEDIUM

(71) Applicant: SK Planet Co., Ltd., Seongnam-si (KR)

(72) Inventor: Jee Hyuk KIM, Incheon (KR)

(73) Assignee: SK Planet Co., Ltd.

(21) Appl. No.: 15/967,067

(22) Filed: Apr. 30, 2018

Related U.S. Application Data
(63) Continuation of application No. PCT/KR2016/005595, filed on May 26, 2016.

(30) Foreign Application Priority Data
Oct. 30, 2015 (KR) 10-2015-0151504

(51) Int. Cl. G06Q 30/02; G06Q 20/20; G06K 7/14

(52) U.S. Cl. CPC G06Q 30/0238; G06K 7/1413; G06K 7/1417; G06Q 20/20

(57) ABSTRACT

The present disclosure provides a user equipment, a service providing apparatus, a POS terminal, a payment system including the same, a control method thereof, and non-transitory computer readable storage medium. That is, when it is determined by using a short-range communication scheme such as BLE that a user of the user equipment is positioned at a specific store, information on discount cards and saving cards usable in the corresponding store is provided. After one discount card and one saving card are selected by the user, the selected discount card and saving card are displayed on one screen in a dual barcode form so that discount function according to the selected discount card and saving function according to the selected saving card are performed by the POS terminal. Thereby, user convenience is improved and satisfaction of the user for the payment is also enhanced.

### CROSS-REFERENCE TO RELATED APPLICATION(S)

This application is a Continuation of International Application No. PCT/KR2016/005595, filed on May 26, 2016 and designating the United States, and claims priority to Korean Patent Application No. 10-2015-0151504, filed on Oct. 30, 2015, the entirety of all of which are hereby incorporated by reference herein.

### FIELD

The present disclosure relates to a user equipment, a service providing apparatus, a POS terminal, a payment system including the same, a control method thereof, and a non-transitory computer readable storage medium, and more particularly, to a user equipment, a service providing apparatus, a POS terminal, a payment system including the same, a control method thereof, and a non-transitory computer readable storage medium, in which at the time of performing a payment function according to a product purchase or a service use in a store, when a discount card and a saving card that can be used in the store are simultaneously provided among a plurality of payment cards previously issued to the user equipment, the discount card and the saving card selected by the user of the user equipment are displayed on one screen in a dual barcode form and a discount function and a saving function are performed based on the discount card and the saving card displayed in the dual barcode form in the POS terminal, respectively.

### BACKGROUND

The statements in this section merely provide background information related to the present disclosure and may not constitute prior art.

A user equipment has used a membership card (for example, including a discount card, a saving card, or the like.) pre-registered in the corresponding user equipment at the time of discounting and saving the membership in an affiliate store through an app.

In the case of using the membership discount function or the saving function through the app of the user equipment, the user needs to use a barcode used for discounting and a barcode used for saving, respectively, and thus it may be difficult to provide each barcode to a manager of a POS terminal.

### SUMMARY

The present disclosure provides a user equipment, a service providing apparatus, a POS terminal, a payment system including the same, a control method thereof, and a non-transitory computer readable storage medium, in which when a user of the user equipment is positioned at a specific store by using a short-range communication scheme such as BLE, in the case of providing information on discount cards and saving cards usable in the corresponding store and selecting one discount card and one saving card among them, the selected discount card and saving card are displayed on one screen in a dual barcode form.

Further, the present disclosure provides a user equipment, a service providing apparatus, a POS terminal, a payment system including the same, a control method thereof, and a non-transitory computer readable storage medium, in which while combination information of a discount card and a saving card for each store of the user equipment is stored in advance, in the case of requesting store information on a specific store in the user equipment, combination information on the discount card and the saving card stored in advance in association with the corresponding store is provided in the corresponding user equipment in addition to the store information.

One form of the present disclosure provides a user equipment, which may include: a user equipment communication unit configured to receive unique identification information of a beacon transmitted from the beacon placed in a store, transmit the received unique identification information of the beacon and identification information of the user equipment to a service providing apparatus, and receive store information of the store, one or more of advertising information, one or more of benefit information and a list of recommended cards which are transmitted from the service providing apparatus in response to the transmitted unique identification information of the beacon and the identification information of the user equipment; a user equipment display unit configured to display the received store information, the one or more of advertising information, the one or more of benefit information, and the list of the recommended cards; and a user equipment control unit configured to check one discount card and one saving card selected from the list of the recommended cards displayed on the user equipment display unit according to a user's selection and control the user equipment display unit to simultaneously display a barcode or a QR code associated with the checked discount card and a barcode or a QR code associated with the checked saving card on one screen.

As one example associated with the present disclosure, the user equipment communication unit may transmit combination information of the checked discount card and the saving card according to the user's selection, the store information, and the identification information of the user equipment to the service providing apparatus.

As one example associated with the present disclosure, the user equipment control unit may perform a payment function for a payment amount in which a discount amount corresponding to the discount card and a saving amount corresponding to the saving card are applied to price information corresponding to one or more of product information to be paid or service information to be paid, by interlocking with the user equipment, the POS terminal, the service providing apparatus, and the payment server based on information on the barcode or the QR code associated with the discount card and information on the barcode or the QR code associated with the saving card recognized by the POS terminal. Here, the one or more of product information to be paid or service information to be paid are scanned or checked by the POS terminal.

As one example associated with the present disclosure, the user equipment communication unit may receive a payment function performance result transmitted from the payment server via the POS terminal, the user equipment display unit may display the received payment function performance result, and the payment function performance result may include at least one of a product name, a service name, a product unique code, a service unique code, a unit price, a volume, a discount amount, whether a coupon is applied, a saving amount, an actual payment amount, payment date and time information, a type of the discount card used for payment, and a type of the saving card used for payment.

Another form of the present disclosure provides a user equipment, which may include: a user equipment communication unit configured to receive unique identification information of a beacon transmitted from the beacon placed in a store, transmit the received unique identification information of the beacon and identification information of the user equipment to a service providing apparatus, and receive store information of the store, combination information of a discount card and a saving card, one or more of advertising information, and one or more of benefit information, which are transmitted from the service providing apparatus in response to the transmission; a user equipment display unit configured to display the received store information, the one or more of advertising information, and the one or more of benefit information; and a user equipment control unit configured to control the user equipment display unit to simultaneously display a barcode or a QR code associated with the discount card and a barcode or a QR code associated with the saving card on one screen based on the received combination information of the discount card and the saving card, in order to perform the payment function for the one or more of product information or service information to be paid selected by the user of the user equipment.

Yet another form of the present disclosure provides a control method of a user equipment, which may include the steps of: receiving, by a user equipment communication unit, unique identification information of a beacon transmitted from the beacon placed in a store; transmitting, by the user equipment communication unit, the received unique identification information of the beacon and identification information of the user equipment to a service providing apparatus; receiving, by the user equipment communication unit, store information of the store, one or more of advertising information, one or more of benefit information, and a list of recommended cards which are transmitted from the service providing apparatus in response to the transmission; displaying, by a user equipment display unit, the received store information, the one or more of advertising information, the one or more of benefit information, and the list of the recommended cards; checking, by a user equipment control unit, types of one discount card and one saving card selected from the list of recommended cards displayed on the user equipment display unit according to a user's selection; and displaying, by the user equipment display unit, a barcode or a QR code associated with the checked discount card and a barcode or a QR code associated with the checked saving card simultaneously on one screen.

As one example associated with the present disclosure, the control method of the user equipment may further include steps of transmitting, by the user equipment communication unit, combination information of the checked discount card and the checked saving card according to the user's selection, the store information, and the identification information of the user equipment to the service providing apparatus, in order for management of the combination information of the checked discount card and the checked saving card according to the user's selection.

As one example associated with the present disclosure, the control method of the user equipment may further include steps of performing, by the user equipment control unit, a payment function for a payment amount in which a discount amount corresponding to the discount card and a saving amount corresponding to the saving card are applied to price information corresponding to one or more of product information to be paid or service information to be paid, by interlocking with the user equipment, the POS terminal, the service providing apparatus, and the payment server based on information on the barcode or the QR code associated with the discount card and information on the barcode or the QR code associated with the saving card recognized by the POS terminal, the one or more of product information to be paid or service information to be paid being scanned or checked by the POS terminal; receiving, by the user equipment communication unit, a payment function performance result transmitted from the payment server through the POS terminal; and displaying, by the user equipment display unit, the received payment function performance result.

Still another form of the present disclosure provides a non-transitory computer readable storage medium in which a computer program performing the method according to the aforementioned form may be stored.

Still another form of the present disclosure provides a payment system, which may include: a service providing apparatus configured to receive unique identification information of a beacon transmitted from a user equipment placed in a store and identification information of the user equipment, check store information corresponding to the received unique identification information of the beacon from stored store information for each unique identification information of a plurality of beacons, check one or more of advertising information and one or more of benefit information which can be provided to the user equipment in the store provided with the beacon from a plurality of advertising information and a plurality of benefit information stored in advance, check, when the checked store information and the combination information of the discount card and the saving card corresponding to the received identification information of the user equipment are not included in a plurality of pre-registered store information and the combination information of the discount card and the saving card for each identification information of the user equipment, one or more discount cards and one or more saving cards to which the benefit information is applicable among a plurality of payment cards issued to the user equipment based on the checked one or more of benefit information, generate a list of recommended cards including the checked one or more discount cards and the checked one or more saving cards, and transmit the checked store information, the generated list of recommended cards, the one or more of advertising information, and the one or more of benefit information to the user equipment; and the user equipment configured to display the store information, the list of recommended cards, the one or more of advertising information, and the one or more of benefit information, which are transmitted from the service providing apparatus.

According to the present disclosure, when a user of the user equipment is positioned at a specific store by using a short-range communication scheme such as BLE, in the case of providing information on discount cards and saving cards usable in the corresponding store and selecting one discount card and one saving card among them, the selected discount card and saving card are displayed on one screen in a dual barcode form to perform simply application of the discount function according to a discount card and easily application of a saving function according to a saving card in the POS terminal. Thus, it is possible to improve convenience of the user and enhance satisfaction of the user according to payment.

Further, according to the present disclosure, while combination information of a discount card and a saving card for each store of the user equipment is stored in advance, in the case of requesting store information on a specific store in the user equipment, combination information on the discount card and the saving card stored in advance in association with the corresponding store is provided in the corresponding user equipment in addition to the store information. Thus, it is possible to improve operating efficiency of the payment system and improve convenience of the user.

Further areas of applicability will become apparent from the description provided herein. It should be understood that the description and specific examples are intended for purposes of illustration only and are not intended to limit the scope of the present disclosure.

### DRAWINGS

In order that the disclosure maybe well understood, there will now be described various forms thereof, given by way of example, reference being made to the accompanying drawings, in which:

FIG. 1 is a block diagram illustrating a configuration of a payment system;

FIG. 2 is a block diagram illustrating a configuration of a user equipment;

FIG. 3 is a block diagram illustrating a configuration of a service providing apparatus;

FIGS. 4 to 6 are flowcharts illustrating a control method of a payment system; and

FIGS. 7 to 9 are diagrams illustrating a screen of the user equipment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Technical terms used in the present disclosure are used only to describe specific forms, and are not intended to limit the present disclosure. Further, unless otherwise defined, the technical terms used in the present disclosure should be interpreted as meanings generally appreciated by those skilled in the art and should not be interpreted as excessively comprehensive meanings or excessively reduced meanings. Further, when the technical term used in the present disclosure is a wrong technical term that does not accurately express the spirit of the present disclosure, the technical term should be understood by being substituted by a technical term which can be correctly understood by those skilled in the art. In addition, a general term used in the present disclosure should be interpreted as defined in a dictionary or contextually, and should not be interpreted as an excessively reduced meaning.

Further, singular expressions used in the present disclosure include plural expressions unless they have definitely opposite meanings in the context. In the present disclosure, a term such as “comprising” or “including” should not be interpreted as necessarily including all various components or various steps disclosed in the disclosure, and it should be interpreted that some component or some steps among them may not be included or additional components or steps may be further included.

Further, terms including an ordinary number, such as first and second, and the like are used for describing various components, but the components are not limited by the terms. The above terms are used only to discriminate one component from the other components. For example, a first component may be referred to as a second component, and similarly, the second component may be referred to as the first component without departing from the scope of the present disclosure.

Hereinafter, some forms of the present disclosure will be described in detail with reference to the accompanying drawings, in which like reference numerals refer to like or similar elements regardless of reference numerals and a duplicated description thereof will be omitted.

Further, in the following description, a detailed explanation of known associated technologies may be omitted to avoid unnecessarily obscuring the subject matter of the present disclosure. Further, it is noted that the accompanying drawings are only for easily understanding the spirit of the present disclosure and it should not be interpreted that the spirit of the present disclosure is limited by the accompanying drawings.

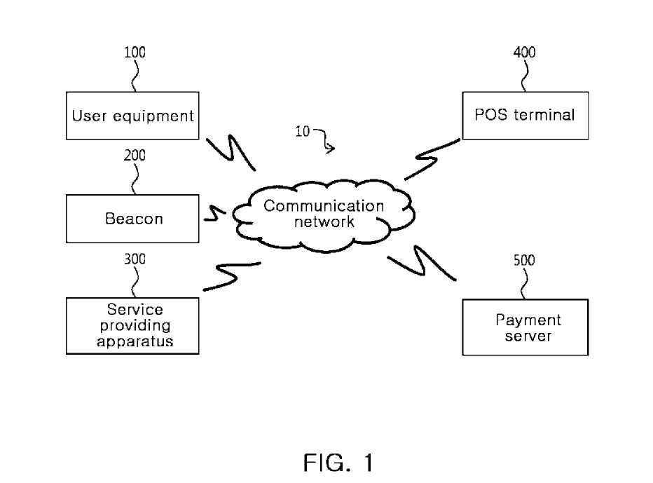

FIG. 1 is a block diagram illustrating a configuration of a payment system 10 in some forms of the present disclosure.

As illustrated in FIG. 1, the payment system 10 is configured by a user equipment 100, a beacon 200, a service providing apparatus 300, a POS terminal 400, and a payment server 500. All the components of the payment system 10 illustrated in FIG. 1 are not required components, and the payment system 10 may be implemented by more components than the components illustrated in FIG. 1 or less components therethan.

When the service providing apparatus 300 receives unique identification information of the beacon 200, identification information of the user equipment 100, and the like transmitted from the user equipment 100 in order to perform a payment function for products or services provided from the service, the service providing apparatus 300 checks store information corresponding to the unique identification information of the corresponding received beacon 200 from the store information for each unique identification information of the plurality of beacons stored in advance, confirms one or more discount cards and one or more saving cards having the largest benefit available in the corresponding store from among one or more payment cards issued in the user equipment 100, generates a list of recommended cards including the discount cards and the saving cards, and then transmits identified store information, a list of recommended cards, one or more of advertising information, one or more of benefit information, etc. to the user equipment 100. Thereafter, the user equipment 100 checks the discount card and the saving card according to the user's selection among one or more discount cards and one or more saving cards displayed on the user equipment 100, and displays a barcode/quick response (QR) code associated with the discount card and a barcode/QR code associated with the saving card checked according to the user's selection on one screen at the same time. Thereafter, with respect to one or more products (or payment products) or services to be paid which are selected by the user, the POS terminal 400 scans the corresponding products to be paid, recognizes the barcode/QR code associated with the discount card and the barcode/QR code associated with the saving card which are displayed on one screen of the user equipment 100, transmits to the payment server 500, information on one or more products or services to be paid, barcode/QR code information associated with the recognized discount card, barcode/QR code information associated with the recognized saving card, the identification information of the POS terminal 400, the identification information of the user equipment 100, and the like. Thereafter, the payment server 500 performs a payment function for a payment amount in which a discounted amount corresponding to the discount card and a payment amount for which the saving amount corresponding to the saving card are applied to price information corresponding to the information on one or more products or services to be paid, based on the barcode/QR code associated with the discount card and the barcode/QR code associated with the saving card, and provides the result of performing the payment function to the user equipment 100 through the POS terminal 400 or the service providing apparatus 300.

The user equipment 100 maybe applied to various terminals, such as a smart phone, a portable terminal, a mobile terminal, a personal digital assistant (PDA), a portable multimedia player (PMP), a telematics terminal, a navigation terminal, a personal computer, a notebook computer, a slate PC, a tablet PC, an ultrabook, a wearable device (for example, including a smartwatch, a smart glass, a head mounted display (HMD), etc.), a Wibro terminal, an Internet protocol television (IPTV) terminal, a smart TV, a digital broadcasting terminal, a television, a 3D television, a home theater system, an audio video navigation (AVN) terminal, an audio/video (A/V) system, and a flexible terminal, etc.

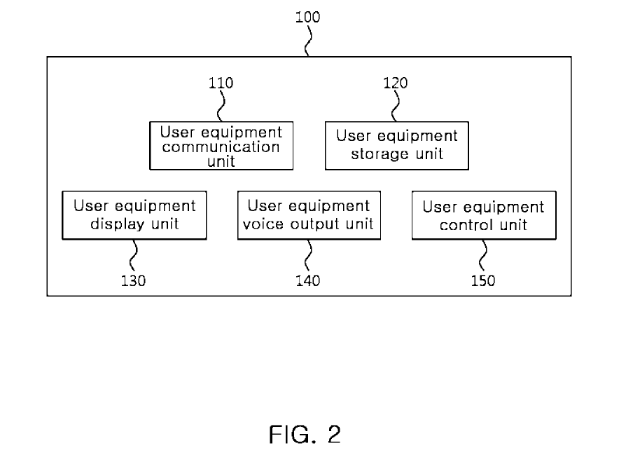

As illustrated in FIG. 2, the user equipment 100 is configured by a user equipment communication unit 110, a user equipment storage unit 120, a user equipment display unit 130, a user equipment voice output unit 140, and a user equipment control unit 150. All the components of the user equipment 100 illustrated in FIG. 2 are not essential components, and the user equipment 100 may be implemented by more components than the components illustrated in FIG. 2 or less components therethan.

The user equipment communication unit 110 communicates with any internal component or at least one any external terminal via a wired/ wireless communication network. In this case, any external terminal may include the beacon 200, the service providing apparatus 300, the POS terminal 400, the payment server 500, and the like. Herein, as a wireless Internet technology, there are wireless LAN (WLAN), digital living network alliance (DLNA), wireless broadband (Wibro), world interoperability for microwave access (WIMAX), highspeed downlink packet access (HSDPA), high speed uplink packet access (HSUPA), IEEE 802.16, long term evolution (LTE), long term evolution-advanced (LTE-A), wireless mobile broadband service (WMBS), and the like. The user equipment communication unit 110 transmits and receives data according to at least on wireless Internet technology in a range including Internet technologies which are not listed above. Further, as the short range communication technology, Bluetooth, radio frequency identification (RFID), Infrared data association (IrDA), ultra wideband (UWB), ZigBee, near field communication (NFC), ultra sound communication (USC), visible light communication (VLC), Wi-Fi, Wi-Fi Direct, and the like maybe included. In addition, as the wired communication technology, power line communication (PLC), USB communication, Ethernet, serial communication, optical/coaxial cables, and the like may be included.

Further, the user equipment communication unit 110 may mutually transmit information with any terminal through a universal serial bus (USB).

Further, the user equipment communication unit 110 transmits and receives wireless signals with a base station, the beacon 200, the service providing apparatus 300, the POS terminal 400, and the payment server 500 on a mobile communication network constructed according to technology standards or communication schemes (for example, GSM(Global System for Mobile communication), CDMA(Code Division Multi Access), CDMA2000(Code Division Multi Access 2000), EV-DO(Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A(Long Term Evolution-Advanced), etc.) for mobile communication.

Further, the user equipment communication unit 110 receives the unique identification information of the corresponding beacon 200 (alternatively, the unique identification information of the store provided with the corresponding beacon 200) transmitted from the beacon 200 by a control of the user equipment control unit 150.

The user equipment storage unit 120 stores various user interfaces (UIs) and graphic user interfaces (GUIs).

Further, the user equipment storage unit 120 stores data, programs, and the like which are required to operate the user equipment 100.

That is, the user equipment storage unit 120 may store a plurality of application programs (alternatively, applications) driven in the user equipment 100 and data, commends, etc. for the operation of the user equipment 100. At least some of the application programs may be downloaded from an external service providing apparatus through wireless communication. Further, at least some of the application programs may be present on the user equipment 100 from a release time for basic functions (for example, call receiving and sending functions and message receiving and sending functions) of the user equipment 100. Meanwhile, the application programs are stored in the user equipment storage unit 120 and installed in the user equipment 100 to be driven to perform an operation (alternatively, a function) of the user equipment 100 by the user equipment control unit 150.

Further, the user equipment storage unit 120 may include at least one storage medium of a flash memory type storage medium, a hard disk type storage medium, a multimedia card micro type storage medium, a card type memory (for example, an SD or XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 100 may operate a web storage performing a storage function of the user equipment storage unit 120 on the Internet or operate in association with the web storage.

Further, the user equipment storage unit 120 stores the unique identification information of the corresponding beacon 200 (alternatively, the unique identification information of the store provided with the corresponding beacon 200) received through the user equipment communication unit 110 by a control of the user equipment control unit 150.

In addition, the user equipment display unit 130 may display various contents such as various menu screens by using a user interface and/or a graphic user interface stored in the user equipment storage unit 120 by the control of the user equipment control unit 150. Herein, the contents displayed on the user equipment display unit 130 include a menu screen and the like including various texts or image data (including various information data) and data such as icons, a list menu, and a combo box, and the like. Further, the user equipment display unit 130 may be a touch screen.

Further, the user equipment display unit 130 may include at least one of a liquid crystal display (LCD), a thin film transistor-liquid crystal display (TFT LCD), an organic light-emitting diode (OLED), a flexible display, a 3D display, an e-ink display, and a light emitting diode (LED).

Further, the user equipment display unit 130 may be constituted as a stereoscopic display unit displaying a stereoscopic image.

A 3D display type such as a stereoscopic type (a glasses type), an auto-stereoscopic type (a glassless type), and a projection type (a holographic type) may be applied to the stereoscopic display unit.

Further, the user equipment display unit 130 display the unique identification information of the corresponding beacon 200 (alternatively, the unique identification information of the store provided with the corresponding beacon 200) received through the user equipment communication unit 110 by a control of the user equipment control unit 150.

The user equipment voice output unit 140 outputs voice information included in a processed signal by the user equipment control unit 150. Herein, the user equipment voice output unit 140 may include a receiver, a speaker, a buzzer, and the like.

Further, the user equipment voice output unit 140 outputs a guide voice generated by the user equipment control unit 150.

Further, the user equipment voice output unit 140 outputs voice information corresponding to the unique identification information of the corresponding beacon 200 (alternatively, the unique identification information of the store provided with the corresponding beacon 200) received through the user equipment communication unit 110 by a control of the user equipment control unit 150.

The user equipment control unit 150 executes overall control functions of the user equipment 100.

Further, the user equipment control unit 150 executes overall control functions of the user equipment 100 by using programs and data stored in the user equipment storage unit 120. The user equipment control unit 150 may include a RAM, a ROM, a CPU, a GPU, and a bus, and the RAM, the ROM, the CPU, and the GPU may be connected to each other through the bus. The CPU accesses the user equipment storage unit 120 to perform booting by using an O/S stored in the user equipment storage unit 120 and may perform various operations by using various programs, contents, data, and the like stored in the user equipment storage unit 120.

Further, the user equipment control unit 150 performs a membership procedure for the user of the corresponding user equipment 100 by interlocking with the service providing apparatus 300.

Further, when the membership procedure is performed, the user equipment control unit 150 may normally complete the membership procedure for the service providing apparatus 300 only when an authentication function is completed through a self-authentication means (for example, including a mobile phone, a credit card, an i-pin, an e-mail, etc.).

Further, when the user having the user equipment 100 enters the store, the user equipment control unit 150 controls the user equipment communication unit 110 to receive the unique identification information of the corresponding beacon 200 (alternatively, the unique identification information of the store provided with the corresponding beacon 200).

Further, after the product or the service provided in the store is used, the user equipment control unit 150 executes a specific app installed in advance in the corresponding user equipment 100 for payment according to a user's input (alternatively, user's selection/control/operation).

Further, the user equipment control unit 150 transmits the unique identification information of the received beacon 200, the identification information of the user equipment 100, and the like to the service providing apparatus 300 through the user equipment communication unit 110. Herein, the identification information of the user equipment 100 includes a mobile directory number (MDN), a mobile IP, a mobile MAC, subscriber identity module (Sim) card unique information, a serial number, and the like.

Further, when the user of the user equipment control unit 150 is not a member pre-registered in the corresponding service providing apparatus 300, the user equipment control unit 150 performs the membership procedure for the corresponding user equipment 100 (alternatively, the user of the corresponding user equipment 100) based on the guide information associated with the membership provided from the service providing apparatus 300.

Further, the user equipment control unit 150 receives store information, one or more of advertising information, one or more of benefit information, a list of recommended cards, and the like transmitted from the service providing apparatus 300 through the user equipment communication unit 110 in response to the unique identification information of the beacon 200, the identification information of the user equipment 100, and the like which are transmitted above. Herein, the corresponding list of recommended cards includes one or more discount cards and one or more saving cards which can be applied (or reflected) with the corresponding benefit information among a plurality of payment cards issued in the corresponding user equipment 100 based on one or more of benefit information usable (alternatively, applicable) in the store. In this case, the benefit information includes coupon information, membership benefit information, discount benefit information, and the like.

Further, when the user of the user equipment control unit 150 is a member pre-registered in the corresponding service providing apparatus 300, the user equipment control unit 150 may also receive store information, one or more of advertising information, one or more of benefit information, a list of recommended cards, and the like transmitted from the service providing apparatus 300 through the user equipment communication unit 110 in response to the unique identification information of the beacon 200, the identification information of the user equipment 100, and the like which are transmitted above.

Further, the user equipment control unit 150 outputs the received store information, one or more of advertising information, one or more of benefit information, a list of recommended cards, and the like through the user equipment display unit 130 and/or the user equipment voice output unit 140.

Further, when the corresponding user equipment 100 has visited the corresponding store and performed the payment function, the user equipment control unit 150 receives, through the user equipment communication unit 110, store information, combination information of the discount card and the saving card, one or more of advertising information, one or more of benefit information, and the like which are transmitted from the service providing apparatus 300 in response to the unique identification information of the beacon 200, the identification information of the user equipment 100, and the like which are transmitted above.

Further, the user equipment control unit 150 outputs the store information, the combination information of the discount card and the saving card, the one or more of advertising information, the one or more of benefit information, and the like which are transmitted, through the user equipment display unit 130 and/or the user equipment voice output unit 140.

Further, the user equipment control unit 150 checks types of one discount card and one saving card (alternatively, unique identification information of the discount card and the saving card) selected (alternatively, adopted) according to a user's input (alternatively, user's selection) in the list of recommended cards displayed on the user equipment display unit 130.

Further, the user equipment control unit 150 transmits the combination information of the discount card and the saving card, the store information (alternatively, the unique identification information of the beacon 200), the identification information of the user equipment 100, and the like which are checked according to the user's selection, to the service providing apparatus 300 through the user equipment communication unit 110.

As such, in a specific store, the combination information of the discount card and the saving card selected by the user equipment 100 is provided to the service providing apparatus 300, and when the user revisits the corresponding store later, the payment function may be easily performed based on the combination information of the discount card and the saving card used at the time of the above payment.

Further, the user equipment control unit 150 simultaneously displays a barcode (alternatively, a QR code) associated with the discount card and a barcode (alternatively, a QR code) associated with the saving card according to the checked user's selection on one screen of the user equipment display unit 130, in order to perform the payment function (for example, including a discount function, a saving function, and the like). In this case, the user equipment control unit 150 may simultaneously display the barcode (alternatively, the QR code) associated with the discount card and the barcode (alternatively, the QR code) associated with the saving card on one screen of the user equipment display unit 130 through various screen division schemes (for example, including top/bottom division, left/right division, a PIP function, etc.).

Further, when the user equipment 100 receives the store information, the combination information of the discount card and the saving card, one or more of advertising information and one or more of benefit information which can be provided to the corresponding user equipment 100 in the store provided with the corresponding beacon 200, and the like, the user equipment control unit 150 simultaneously displays the barcode (alternatively, the QR code) associated with the discount card and the barcode (alternatively, the QR code) associated with the saving card received above on one screen, in order to perform the payment function (for example, including a discount function, a saving function, etc.).

Further, when the user of the user equipment 100 performs the payment function for one or more products to be paid (alternatively, payment products) selected by the user or the service selected (alternatively, used) by the user of the user equipment 100, the user equipment control unit 150 performs a payment function for the payment amount to which the discount amount corresponding to the discount card and the saving amount corresponding to the saving card are applied to the price information corresponding to one or more of product/service information to be paid by interlocking with the service providing apparatus 300, the POS terminal 400, and the payment server 500.

Further, after the payment function is normally performed, the user equipment control unit 150 receives the payment function performance result transmitted from the POS terminal 400 through the communication unit 110.

Further, the user equipment 100 outputs the received payment function performance result through the user equipment display unit 130 and/or the user equipment voice output unit 140.

Further, when the user having the corresponding user equipment 100 revisits the corresponding store later, the user equipment control unit 150 transmits unique identification information of the beacon 200 transmitted from the beacon 200, the identification information of the user equipment 100, and the like, to the service providing apparatus 300 through the user equipment communication unit 110.

Further, the user equipment control unit 150 receives the store information transmitted from the service providing apparatus 300 according to revisit, the combination information of the discount card and the saving card, one or more of advertising information and one or more of benefit information which can be provided in the corresponding user equipment 100 in the store provided with the corresponding beacon 200, and the like, through the user equipment communication unit 110.

Further, the user equipment control unit 150 outputs the received store information, the combination information of the discount card and the saving card, the one or more of advertising information which can be provided to the corresponding user equipment 100 in the store provided with the corresponding beacon 200, the one or more of benefit information, and the like, through the user equipment display unit 130 and/or the user equipment voice output unit 140.

Further, the user equipment 100 may further include an interface unit (not illustrated) serving as an interface with all external devices connected to the corresponding user equipment 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Herein, the identification module is a chip storing a variety of information for authenticating permission of the user equipment 100, and may include a user identity module (UIM), a subscriber identity module (SIM), a universal subscriber identity module (USIM), and the like. Further, the device provided with the identification module may be prepared in a smart card form. Accordingly, the identification module may be connected with the user equipment 100 through the port. Such an interface unit receives data or power from an external device to transmit the received data or power to each component in the user equipment 100 or transmit the data in the user equipment 100 to the external device.

Further, the interface unit may be a passage through which the power from a cradle is supplied to the corresponding user equipment 100 when the user equipment 100 is connected with an external cradle or a passage through which various command signals input from the cradle by the user is transferred to the corresponding user equipment 100. Various command signals input from the cradle or the corresponding power may also operate as a signal for recognizing that the user equipment 100 is accurately installed on the cradle.

Further, the user equipment 100 may further include an input unit (not illustrated) for receiving a signal according to a button operation or any function selection by the user or receiving a command or a control signal generated by an operation such as touching/scrolling the displayed screen.

The input unit as a means for receiving at least one of a user's command, selection, data, and information may include a plurality of input keys and function keys for receiving figure or text information and setting various functions.

Further, the input unit may adopt various devices such as a key pad, a dome switch, a touch pad (constant pressure type/capacitive type), a touch screen, a jog wheel, a jog switch, a jog shuttle, a mouse, a stylus pen, and a touch pen. Particularly, when the user equipment display unit 130 is formed in a touch screen form, some or all of the input functions may be performed by the user equipment display unit 130.

Further, each component (alternatively, each module) of the user equipment 100 may be software stored on a memory (alternatively, the user equipment storage unit 120) of the user equipment 100. The memory may be an internal memory of the user equipment 100 and may an external memory or other types of storage devices. Further, the memory may be a nonvolatile memory. The software stored on the memory may include a command set to allow the user equipment 100 to perform a specific operation while executing.

The beacon 200 communicates with the user equipment 100, the POS terminal 400, and the like.

Further, the beacon 200 broadcasts (alternatively, transmits) the unique identification information of the corresponding beacon 200 (alternatively, the unique identification information of the store provided with the corresponding beacon 200), and the like at a predetermined cycle (for example, 200 ms).

Further, the beacon 200 receives store information associated with the store provided with the corresponding beacon 200, unique identification information of the store provided with the corresponding beacon 200, and the like, which are transmitted from the POS terminal 400.

Further, the beacon 200 broadcasts (alternatively, transmits) the store information, the unique identification information of the corresponding beacon 200 (alternatively, the unique identification information of the store provided with the corresponding beacon 200), and the like at a predetermined cycle (for example, 200 ms).

The service providing apparatus 300 communicates with the user equipment 100, the POS terminal 400, the payment server 500, and the like.

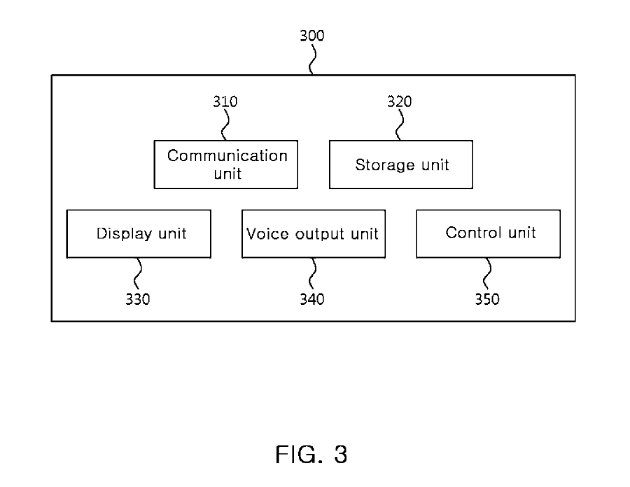

As illustrated in FIG. 3, the user equipment 100 is constituted by a communication unit 310, a storage unit 320, a display unit 330, a voice output unit 340, and a control unit 350. All the components of the user equipment 100 illustrated in FIG. 3 are not essential components, and the user equipment 100 may be implemented by more components than the components illustrated in FIG. 3 or less components therethan.

Further, the control unit 350 performs a membership procedure for the user of the corresponding user equipment 100 by interlocking with the user equipment 100.

Further, the control unit 350 receives unique identification information of the beacon 200 transmitted from the user equipment 100, identification information of the user equipment 100, and the like through the communication unit 310.

Further, the control unit 350 determines (alternatively, checks) whether the user corresponding to the user equipment 100 is a member pre-registered (alternatively, subscribed) in the corresponding service providing apparatus 300 based on the received identification information of the corresponding user equipment 100.

As the determined result (alternatively, the checked result), when the user corresponding to the user equipment 100 is not the member pre-registered in the corresponding service providing apparatus 300, the control unit 350 transmits guide information associated with the membership to the user equipment 100 through the communication unit 310.

Further, the control unit 350 performs a membership procedure for the corresponding user equipment 100 (alternatively, the user of the corresponding user equipment 100) by interlocking with the user equipment 100.

Further, the control unit 350 may check store information corresponding to the unique identification information of the received beacon 200 among store information for each unique identification information of a plurality of beacons stored in advance in the storage unit 320 (alternatively, unique identification information of a plurality of beacons stored in advance for each store information).

Further, the control unit 350 checks one or more of advertising information, one or more of benefit information, and the like which can be provided to the corresponding user equipment 100 in the store provided with the corresponding beacon 200 in a plurality of advertising information and a plurality of benefit information stored in advance based on the unique identification information of the corresponding beacon 200 and the identification information of the user equipment which are received above.

Further, the control unit 350 checks (alternatively, determines) whether the checked store information and the combination information of the discount card and the saving card corresponding to the received identification information of the corresponding user equipment 100 are present in a plurality of store information pre-registered (or stored) in the storage unit 320 and the combination information of the discount card and the saving card for each identification information of the user equipment.

That is, the control unit 350 checks (alternatively, determines) whether the checked store information and the combination information of the discount card and the saving card corresponding to the received identification information of the corresponding user equipment 100 are included in the plurality of store information pre-registered (or stored) in the storage unit 320 and the combination information of the discount card and the saving card for each identification information of the user equipment.

As the checked result (alternatively, the determined result), when the checked store information and the combination information of the discount card and the saving card corresponding to the received identification information of the corresponding user equipment 100 are included in the pre-registered plurality of store information and the combination information of the discount card and the saving card for each identification information of the user equipment, the control unit 350 checks the store information and the combination information of the discount card and the saving card corresponding to the identification information of the user equipment 100.

Further, the control unit 350 transmits the checked store information, the checked combination information of the discount card and the saving card, one or more of advertising information and one or more of benefit information which can be provided in the corresponding user equipment 100 in the store provided with the corresponding beacon 200, and the like, to the user equipment 100 through the communication unit 310.

Further, as the checked result (alternatively, the determined result), when the user corresponding to the corresponding user equipment 100 is the member pre-registered in the corresponding service providing apparatus 300, the control unit 350 may transmit the checked store information, the checked combination information of the discount card and the saving card, one or more of advertising information and one or more of benefit information which can be provided in the corresponding user equipment 100 in the store provided with the corresponding beacon 200, and the like, to the user equipment 100 through the communication unit 310.

As such, with respect to the user equipment 100 visiting the same store, the control unit 350 provides information on a discount card and a saving card having the largest benefit in the corresponding store stored in advance in associated with the corresponding user equipment 100 to the user equipment 100, thereby improving convenience of the user of the user equipment 100 and reducing a load of the service providing apparatus 300.

Further, as the checked result (alternatively, the determined result), when the checked store information and the combination information of the discount card and the saving card corresponding to the received identification information of the corresponding user equipment 100 are not included in the pre-registered plurality of store information and the combination information of the discount card and the saving card for each identification information of the user equipment, the control unit 350 checks one or more discount cards and one or more saving cards that can apply (or reflect) the corresponding benefit information among the plurality of payment cards issued to the user equipment 100 based on the checked one or more of benefit information. In this case, the benefit information includes coupon information, membership benefit information, discount benefit information, and the like. In this case, the payment card includes a credit card, a cash card (alternatively, a check card), a point card, and the like to which a discount benefit/a saving benefit can be applied.

That is, when the checked store information and the combination information of the discount card and the saving card corresponding to the received identification information of the corresponding user equipment 100 are not included in the pre-registered plurality of store information and the combination information of the discount card and the saving card for each identification information of the user equipment, the control unit 350 checks one or more discount cards and one or more saving cards having the largest benefit which are usable in the corresponding store among the plurality of cards issued to the user equipment 100, respectively.

Further, the control unit 350 generates a recommendation card lit including the checked one or more discount cards and one or more saving cards.

Further, the control unit 350 transmits the checked store information, one or more of advertising information, one or more of benefit information, the generated list of recommended cards, and the like to the user equipment 100 through the communication unit 310.

Further, the control unit 350 receives the combination information of the discount card and the saving card transmitted from the user equipment 100, the store information (alternatively, the unique identification information of the beacon 200), the identification information of the user equipment 100, and the like, which are transmitted from the user equipment 100, through the communication unit 310.

Further, the control unit 350 stores (alternatively, manages) the received combination information of the discount card and the saving card, the store information (alternatively, the unique identification information of the beacon 200), the identification information of the user equipment 100, and the like by mapping (alternatively, matching/interlocking).

That is, the control unit 350 generates store information and combination information of a discount card and a saving card for each identification information of the user equipment by mapping (alternatively, matching/interlocking) the received combination information of the discount card and the saving card, the store information (alternatively, the unique identification information of the beacon 200), the identification information of the user equipment 100, and the like and stores the generated store information and combination information of the discount card and the saving card for each identification information of the user equipment in the storage unit 320.

Further, when the user of the user equipment 100 intends to perform the payment function for one or more products to be paid (alternatively, payment products) selected by the user or the service selected (alternatively, used) by the user of the user equipment 100, the control unit 350 performs a payment function for the payment amount to which the discount amount corresponding to the discount card and the saving amount corresponding to the saving card are applied to the price information corresponding to one or more of product/service information to be paid by interlocking with the service providing apparatus 100, the POS terminal 400, and the payment server 500.

Further, after the payment function is normally performed, the control unit 350 receives the payment function performance result transmitted from the POS terminal 400 through the communication unit 310.

Further, the control unit 350 outputs the received payment function performance result through the display unit 330 and/or the voice output unit 340.

Further, the control unit 350 stores the received payment function performance result in the storage unit 320.

Further, the service providing apparatus 300 may be embodied in forms of a web server, a database server, a proxy server, and the like. Further, in the service providing apparatus 300, at least one of a network load distribution mechanism and various software which allow the service providing apparatus 300 to operate on the Internet or other networks may be installed, and as a result, the service providing apparatus 200 may be embodied by a computerized system. Further, the network may be an http network and may be a private line, Intranet, or any other networks. Furthermore, the service providing apparatus 300 and the user equipment 100 may be connected to each other by a security network so as to prevent the data from being attacked by any hacker or other third parties. Further, the service providing apparatus 300 may include a plurality of database servers, and the database server may be embodied to be separately connected with the mobile card service providing apparatus 300 through any type of network connection including a distributed database sever architecture.

Further, a processor mounted on the user equipment 100 or the service providing apparatus 300 in some forms of the present disclosure may process a program command for executing the method according to the present disclosure. In an exemplary form of the present disclosure, the processor may be a single-threaded processor, and in another exemplary form of the present disclosure, the present processor may be a multi-threaded processor. Further, the processor may process a command stored in the memory or a storage device.

The POS (Point of Sales) terminal 400 communicates with the user equipment 100, the beacon 200, the service providing device 300, the payment server 500, and the like

Further, the POS terminal 400 may include a communication unit (not illustrated), a storage unit (not illustrated), a display unit (not illustrated), a voice output unit (not illustrated), and a control unit (not illustrated) which correspond to the user equipment communication unit 110, the user equipment storage unit 120, the user equipment display unit 130, the user equipment voice output unit 140, and the user equipment control unit 150, respectively, which are included in the user equipment 100.

Further, the POS terminal 400 transmits store information associated with the store provided with the corresponding beacon 200, unique identification information of the store provided with the corresponding beacon 200, and the like, to the beacon 200.

Further, the POS terminal 400 scans (alternatively, recognizes the barcode attached to the corresponding product to be paid) with respect to one or more products (alternatively, payment products) to be paid selected by the user of the user equipment 100.

Further, the POS terminal 400 displays product information for one or more scanned (alternatively, recognized) products to be paid. Herein, the product information includes a product name, a product unique code, a unit price, a volume, an amount of money, a sum total amount, and the like.

Further, the POS terminal 400 may check service information on the service to be paid with respect to the service selected (or used) by the user of the user equipment 100 and display the checked service information. Herein, the service information includes a service name, a service unique code, a unit price, a volume, an amount of money, a sum total amount, and the like.

Further, the POS terminal 400 may recognize (or scan/tag) a barcode (alternatively, a QR code) associated with the discount card and a barcode (alternatively, a QR code) associated with the saving card, which are displayed on one screen of the user equipment 100.

Further, the POS terminal 400 transmits to the payment server 500 the recognized (alternatively, checked) information on one or more products/services to be paid, the checked barcode (alternatively, the QR code) associated with the discount card, the checked barcode (alternatively, the QR code) associated with the saving card, the identification information on the POS terminal 400, the identification information on the user equipment 100, and the like.

Further, when the user of the user equipment 100 intends to perform the payment function for one or more products to be paid (alternatively, payment products) selected by the user or the service selected (alternatively, used) by the user of the user equipment 100, the POS terminal 400 performs a payment function for the payment amount in which the discount amount corresponding to the discount card and the saving amount corresponding to the saving card are applied to the price information corresponding to one or more of product/service information to be paid by interlocking with the user equipment 100, the service providing apparatus 300, and the payment server 500.

When the payment function is failed, the POS terminal 400 receives authentication failure information transmitted from the payment server 500 in response to the transmitted one or more of product/service information to be paid, the barcode (alternatively, the QR code) associated with the discount card, the barcode (alternatively, the QR code) associated with the saving card, the identification information on the POS terminal 400, the identification information on the user equipment 100, and the like.

Further, the POS terminal 400 displays the received authentication failure information.

Further, the POS terminal 400 may transmit the received authentication failure information to the user equipment 100.

When the payment function is normally performed, the POS terminal 400 receives the payment function performance result transmitted form the payment server 500. Herein, the payment function performance result (alternatively, the payment information) includes a product name used for payment (alternatively, a service name), a product unique code used for payment (alternatively, a service unique code), a unit price, a volume, a discount amount, whether a coupon is applied, a saving amount, an amount, an actual payment amount (alternatively, a total payment amount), payment date and time information, a payment card type (for example, a discount card used for payment, a credit card used for payment, etc.).

Further, the POS terminal 400 transmits the received payment function performance result to the user equipment 100.

Further, the POS terminal 400 may output the received payment function performance result through a printed matter such as a receipt and the like.

The payment server 500 communicates with the user equipment 100, the service providing apparatus 300, the POS terminal 400, and the like.

Further, the payment server 500 may include a communication unit (not illustrated), a storage unit (not illustrated), a display unit (not illustrated), a voice output unit (not illustrated), and a control unit (not illustrated) which correspond to the user equipment communication unit 110, the user equipment storage unit 120, the user equipment display unit 130, the user equipment voice output unit 140, and the user equipment control unit 150, respectively, which are included in the user equipment 100.

Further, the payment server 500 receives the one or more of product/service information to be paid, the barcode (alternatively, the QR code) associated with the discount card, the barcode (alternatively, the QR code) associated with the saving card, the identification information on the POS terminal 400, the identification information on the user equipment 100, and the like, which are transmitted from the POS terminal 400.

Further, the payment server 500 performs the payment function for the payment amount in which the discount amount corresponding to the discount card and the saving amount corresponding to the saving card are applied to the price information corresponding to one or more of product/service information to be paid, by interlocking with the user equipment 100, the service providing apparatus 300, and the POS terminal 400, based on the received barcode information (alternatively, the QR code information) associated with the discount card and the barcode information (alternatively, the QR code information) associated with the saving card.

When the payment function execution is failed, the payment server 500 generates authentication failure information and transmits the generated authentication failure information to the POS terminal 400, the service providing apparatus 300, the user equipment 100, and the like.

Further, when the payment function is normally performed, the payment server 500 transmits the payment function performance result to the POS terminal 400, the service providing apparatus 300, and the like. Herein, the payment function performance result (alternatively, the payment information) includes a product name (alternatively, a service name), a product unique code (alternatively, a service unique code), a unit price, a volume, a discount amount, whether a coupon is applied, a saving amount, an amount of money, an actual payment amount (alternatively, a total payment amount), payment date and time information, a payment card type (for example, including a discount card used for payment/a type of discount card, a credit card used for payment/a type of saving card, etc.).

As such, by using a short-range communication scheme such as BLE, when the user of the user equipment is positioned at a specific store, information on discount cards and saving cards usable in the corresponding store is provided, and when one discount card and one saving card thereof are selected, the selected discount card and saving card maybe displayed on one screen in a dual barcode form.

Further, as such, while the combination information of the discount card and the saving card for each store of the user equipment is stored in advance in the service providing apparatus, when the user equipment requests the store information on the specific store, the combination information of the discount card and the saving card stored in advance may be provided to the corresponding user equipment in association with the corresponding store in addition to the corresponding store information.

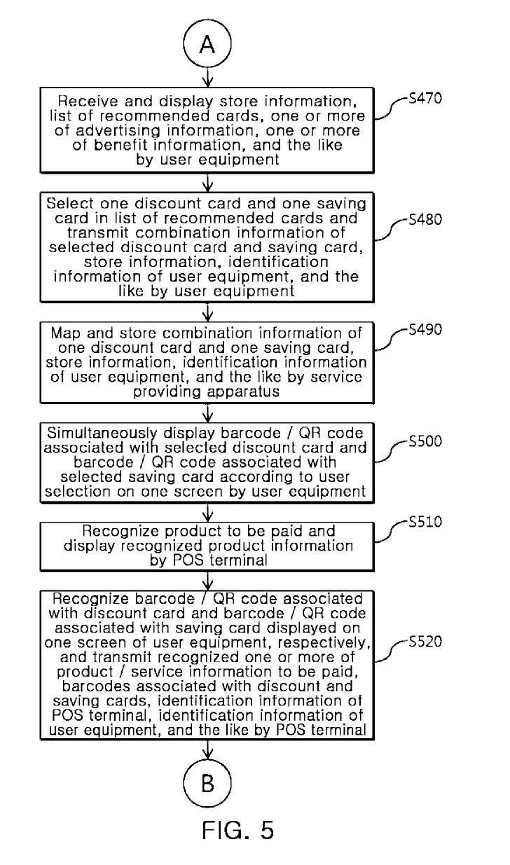

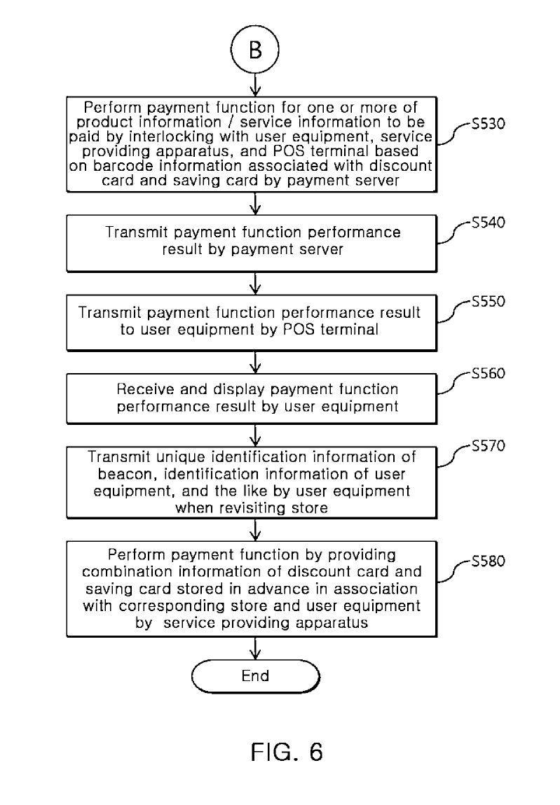

Hereinafter, a control method of a payment system in some forms the present disclosure will be described in detail with reference to FIGS. 1 to 9.

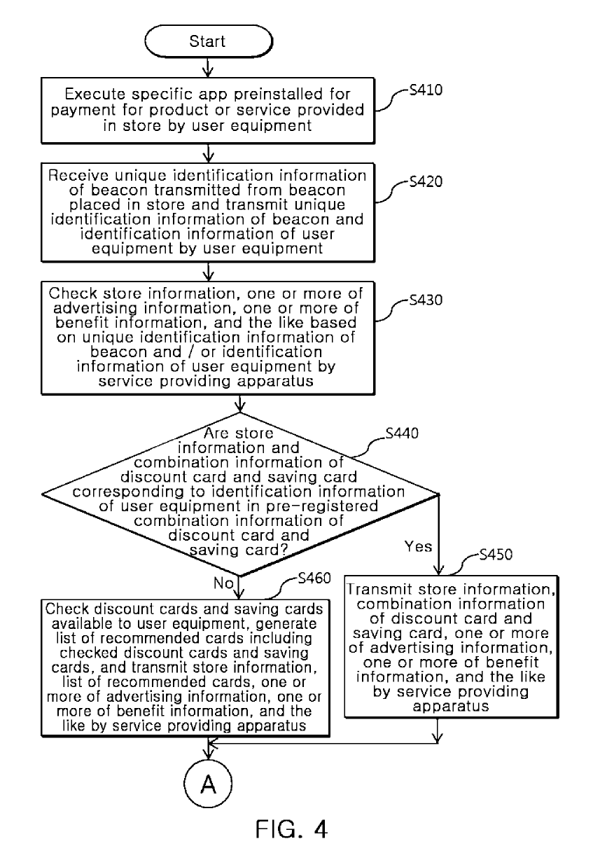

FIGS. 4 to 6 are flowcharts illustrating a control method of a payment system in another form of the present disclosure.

First, after a product or a service provided in the store is used, the user equipment 100 executes a specific app preinstalled in the corresponding user equipment 100 for payment.

As an example, when first user equipment 100 performs a payment function for 11-th to 13-th products provided in a store AA, the first user equipment executes an electronic wallet app preinstalled in the first user equipment and displays the electronic wallet app execution result (S410).

Thereafter, the user equipment 100 receives unique identification information of the beacon 200 (alternatively, unique identification information of the store provided with the corresponding beacon 200) transmitted from the beacon 200 provided in the store.

Further, the user equipment 100 transmits the received unique identification information of the beacon 200, the identification information of the user equipment 100, and the like to the service providing apparatus 300. Herein, the identification information of the user equipment 100 includes a MDN, a mobile IP, a mobile MAC, subscriber identity module (Sim) card unique information, a serial number, and the like.

As an example, the firs user equipment receives the unique identification information of the beacon 200 broadcasted (alternatively, transmitted) from the beacon 200 provided in the store AA through the corresponding electronic wallet app in a background state and transmits the received unique identification information of the beacon 200, the identification information of the first user equipment 100, and the like to the service providing apparatus 300 (S420).

Thereafter, the service providing apparatus 300 receives the unique identification information of the beacon 200, the identification information of the user equipment 100, and the like, which are transmitted from the user equipment 100.

Further, the service providing apparatus 300 may check store information corresponding to the received unique identification information of the beacon 200 among store information for each unique identification information of a plurality of beacons stored in advance (alternatively, unique identification information of a plurality of beacons stored in advance for each store information).

Further, the service providing apparatus 300 checks one or more of advertising information, one or more of benefit information, and the like which can be provided to the corresponding user equipment 100 in the store provided with the corresponding beacon 200 in a plurality of advertising information and a plurality of benefit information stored in advance based on the unique identification information of the corresponding beacon 200 and the identification information of the user equipment which are received above.

As an example, the service providing apparatus 300 checks information on the store AA (for example, store information of restaurant AA) corresponding to the unique identification information of the corresponding beacon 200 among the store information for each unique identification information of the plurality of beacons stored in advance. Further, the service providing apparatus 300 checks first to third advertising information and first to second benefit information (for example, including discount coupon information, membership benefit information, and the like) which can be provided to the first user equipment in the corresponding store AA based on the checked AA store information and the identification information of the first user equipment (S430).

Further, the service providing apparatus 300 checks (alternatively, determines) whether the checked store information and the combination information of the discount card and the saving card corresponding to the received identification information of the corresponding user equipment 100 are present in a plurality of store information pre-registered (or stored) and the combination information of the discount card and the saving card for each identification information of the user equipment.

That is, the service providing apparatus 300 checks (alternatively, determines) whether the checked store information and the combination information of the discount card and the saving card corresponding to the received identification information of the corresponding user equipment 100 are included in the plurality of store information pre-registered (or stored) and the combination information of the discount card and the saving card for each identification information of the user equipment.

As an example, the service providing apparatus 300 checks (alternatively, determines) whether the checked AA store information and the received combination information of the discount card and the saving card corresponding to the identification information of the corresponding first user equipment are included in the plurality of store information pre-registered (or stored) in the corresponding service providing apparatus 300 and the combination information of the discount card and the saving card for each identification information of the user equipment (S440).

As the checked result (alternatively, the determined result), when the checked store information and the combination information of the discount card and the saving card corresponding to the received identification information of the corresponding user equipment 100 are included in the pre-registered plurality of store information and the combination information of the discount card and the saving card for each identification information of the user equipment, the service providing apparatus 300 checks the store information and the combination information of the discount card and the saving card corresponding to the identification information of the corresponding user equipment 100.

Further, the service providing apparatus 300 transmits the checked store information, the checked combination information of the discount card and the saving card, one or more of advertising information and one or more of benefit information which can be provided in the corresponding user equipment 100 in the store provided with the corresponding beacon 200, and the like, to the user equipment 100.

As an example, when the checked AA store information and the received combination information of the discount card and the saving card corresponding to the identification information of the first user equipment are included in a plurality of store information pre-registered in the corresponding service providing apparatus 300 and the combination information of the discount card and the saving card for each identification information of the user equipment, the service providing apparatus 300 transmits to the first user equipment the AA store information, combination information of a BB discount card and a CC saving card corresponding to the received identification information of the first user equipment, first to third advertising information and first to second benefit information (for example, including discount coupon information, membership benefit information, etc.) which can be provided to the corresponding first user equipment in the corresponding AA store, AA store information (for example, AA restaurant store information), and the like.

As such, with respect to the user equipment 100 visiting the same store, the service providing apparatus 300 provides information on a discount card and a saving card having the largest benefit in the corresponding store stored in advance in associated with the corresponding user equipment 100 to the user equipment 100, thereby improving convenience of the user of the user equipment 100 and reducing a load of the service providing apparatus 300 (S450).

Further, as the checked result (alternatively, the determined result), when the checked store information and the received combination information of the discount card and the saving card corresponding to the identification information of the corresponding user equipment 100 are not included in the pre-registered plurality of store information and the combination information of the discount card and the saving card for each identification information of the user equipment, the service providing apparatus 300 checks one or more discount cards and one or more saving cards that can apply (or reflect) the corresponding benefit information among the plurality of payment cards issued to the user equipment 100 based on the checked one or more of benefit information and generates a list of recommended cards including the checked one or more discount cards and one or more saving cards. Herein, the benefit information includes coupon information, membership benefit information, discount benefit information, and the like. In this case, the payment card includes a credit card, a cash card (alternatively, a check card), a point card, and the like to which a discount benefit/a saving benefit can be applied.

That is, when the checked store information and the combination information of the discount card and the saving card corresponding to the received identification information of the corresponding user equipment 100 are not included in the pre-registered plurality of store information and the combination information of the discount card and the saving card for each identification information of the user equipment, the service providing apparatus 300 checks one or more discount cards and one or more saving cards having the largest benefit which are usable in the corresponding store among the plurality of cards issued to the user equipment 100, respectively, and generates a list of recommended cards including the checked one or more discount cards and one or more saving cards.

Further, the service providing apparatus 300 transmits the checked store information, one or more of advertising information, one or more of benefit information, the generated list of recommended cards, and the like to the user equipment 100.

As an example, when the checked AA store information and the received combination information of the discount card and the saving card corresponding to the identification information of the first user equipment are not included in a plurality of store information pre-registered in the corresponding service providing apparatus 300 and the combination information of the discount card and the saving card for each identification information of the user equipment, the service providing apparatus 300 generates a list of recommended cards including a AA discount card to which the first and second benefit information is applicable (for example, when paying 30,000 won or more, 15% discount on a payment amount or an AA discount payment card) and a BB discount card (for example, when paying 100,000 won or more, 10% discount on a payment amount, or a BB discount payment card), and a CC saving card (for example, 5% saving or a CC saving payment card).

Further, the service providing apparatus 300 transmits the AA store information (for example, the AA restaurant store information), the first to third advertising information and the first to second benefit information (for example, including discount coupon information, membership benefit information, etc.), the list of recommended cards including the AA discount card, the BB discount card, and the CC saving card, and the like to the first user equipment (S460).

Thereafter, the user equipment 100 receives store information, one or more of advertising information, one or more of benefit information, a list of recommended cards, and the like transmitted from the service providing apparatus 300 in response to the unique identification information of the beacon 200, the identification information of the user equipment 100, and the like which are transmitted above.

Further, the user equipment 100 displays the received store information, one or more of advertising information, one or more of benefit information, the list of recommended cards, and the like.

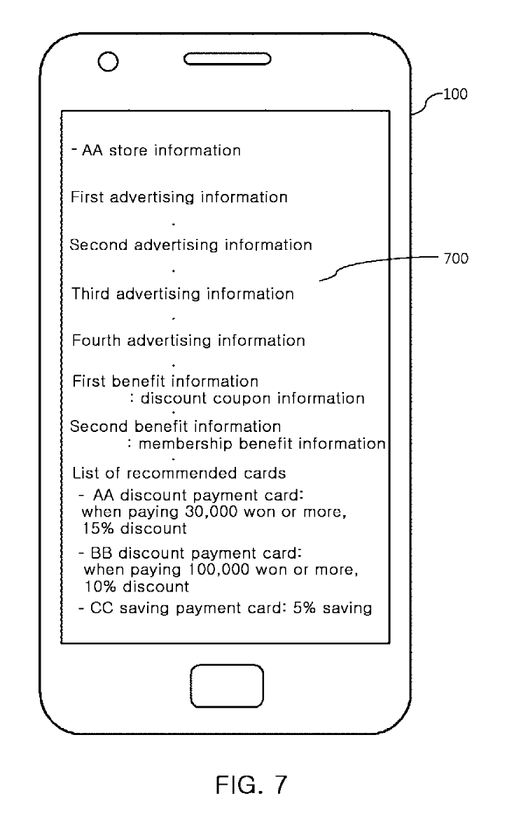

As an example, as illustrated in FIG. 7, the first user equipment displays (700) the AA store information (for example, the AA restaurant store information), the first to third advertising information and the first to second benefit information (for example, including discount coupon information, membership benefit information, etc.), the list of recommended cards including the AA discount card, the BB discount card, and the CC saving card, and the like transmitted from the service providing apparatus 300, through an electronic wallet app.

Further, the user equipment 100 receives store information, combination information of a discount card and a saving card, one or more of advertising information, one or more of benefit information, and the like which are transmitted from the service providing apparatus 300 in response to the unique identification information of the beacon 200, the identification information of the user equipment 100, and the like which are transmitted above.

Further, the user equipment 100 displays the received store information, the combination information of a discount card and a saving card, one or more of advertising information, one or more of benefit information, and the like.

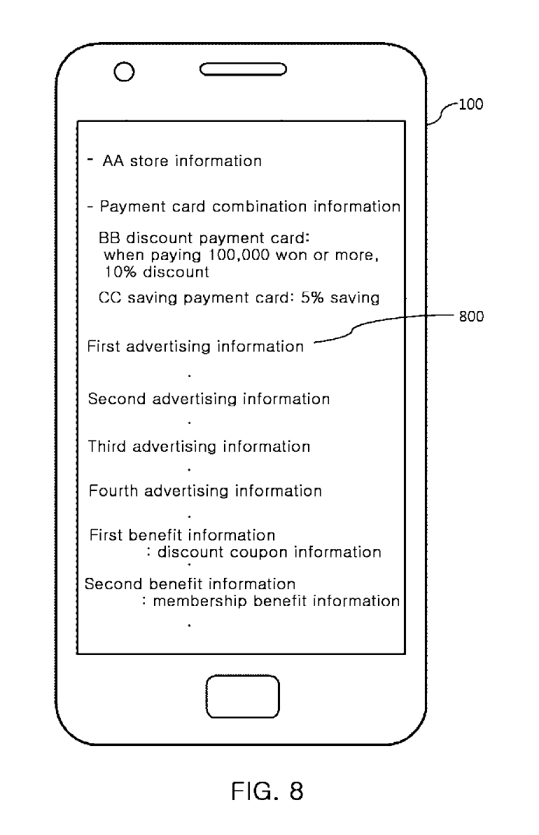

As another example, as illustrated in FIG. 8, the first user equipment displays (800) the AA store information (for example, the AA restaurant store information), combination information of the BB discount card and the CC saving card, the first to third advertising information and the first to second benefit information (for example, including discount coupon information, membership benefit information, etc.), and the like transmitted from the service providing apparatus 300, through an electronic wallet app (S470).

Thereafter, the user equipment 100 checks a type of one discount card and a type of one saving card (alternatively, unique identification information of the discount card and the saving card) selected (alternatively, adopted) according to a user's input (alternatively, user's selection) in the list of recommended cards displayed on the corresponding user equipment 100, respectively.

Further, the user equipment 100 transmits the combination information of the discount card and the saving card, the store information (alternatively, the unique identification information of the beacon 200), the identification information of the user equipment 100, and the like which are checked according to the user's selection, to the service providing apparatus 300.

As an example, the first user equipment checks one discount card (for example, AA discount card) and one saving card (for example, CC card) selected from the list of recommended cards displayed on the corresponding first user equipment, respectively. Further, the user equipment 100 transmits information (alternatively, combination information of the AA discount card and the CC saving card) on the checked AA discount card and CC saving card (alternatively, a type of AA discount card and a type of CC saving card), AA store information, identification information of the first user equipment, and the like to the service providing apparatus 300 (S480).

Thereafter, the service providing apparatus 300 receives the combination information of the discount card and the saving card, the store information (alternatively, the unique identification information of the beacon 200), the identification information of the user equipment 100, and the like, which are transmitted from the user equipment 100.

Further, the service providing apparatus 300 stores (alternatively, manages) the received combination information of the discount card and the saving card, the store information (alternatively, the unique identification information of the beacon 200), the identification information of the user equipment 100, and the like by mapping (alternatively, matching/interlocking).

As an example, the service providing apparatus 300 receives the information (alternatively, the combination information of the AA discount card and the CC saving card) on the AA discount card and CC saving card (alternatively, a type of AA discount card and a type of CC saving card), the AA store information, the identification information of the first user equipment, and the like which are transmitted from the first user equipment and maps and stores the received information (alternatively, the combination information of the AA discount card and the CC saving card) on the AA discount card and CC saving card (alternatively, a type of AA discount card and a type of CC saving card),), the AA store information, the identification information of the first user equipment, and the like (S490).

Thereafter, the user equipment 100 simultaneously displays a barcode (alternatively, a QR code) associated with the discount card and a barcode (alternatively, a QR code) associated with the saving card according to the checked user's selection on one screen, in order to perform the payment function (for example, including a discount function, a saving function, and the like).

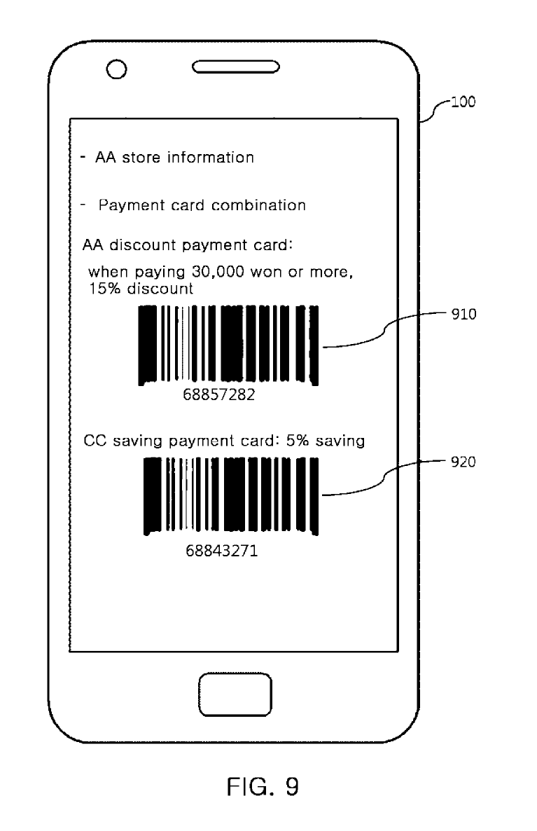

For example, as illustrated in FIG. 9, the first user equipment simultaneously displays the checked AA discount card and a barcode 910 for the corresponding AA discount card and the checked CC saving card and a barcode 920 for the corresponding CC saving card on one screen.

Further, when the user equipment 100 receives the store information, the combination information of the discount card and the saving card, one or more of advertising information and one or more of benefit information which can be provided to the corresponding user equipment 100 in the store provided with the corresponding beacon 200, and the like, which are transmitted from the service providing apparatus 300, the user equipment 100 simultaneously displays the barcode (alternatively, the QR code) associated with the discount card and the barcode (alternatively, the QR code) associated with the saving card received above on one screen, in order to perform the payment function (for example, including a discount function, a saving function, etc.) (S500).

Thereafter, the POS terminal 400 scans the corresponding product to be paid (alternatively, recognizes the barcode attached to the corresponding product to be paid) with respect to one or more products (alternatively, payment products) to be paid selected by the user of the user equipment 100.

Further, the POS terminal 400 displays product information for one or more scanned (alternatively, recognized) products to be paid. Herein, the product information includes a product name, a product unique code, a unit price, a volume, an amount of money, a sum total amount, and the like.

Further, the POS terminal 400 may check service information on the service to be paid with respect to the service selected (or used) by the user of the user device 100 and display the checked service information. Herein, the service information includes a service name, a service unique code, a unit price, a volume, an amount of money, a sum total amount, and the like.

For example, with respect to 11-th to 13-th products selected by the user of the first user equipment, the POS terminal 400 recognizes barcodes attached to the 11-th to 13-th products, respectively, and displays product information on the recognized 11-th to 13-th products (S510).

Thereafter, the POS terminal 400 may recognize (or scan/tag) a barcode (alternatively, a QR code) associated with the discount card and a barcode (alternatively, a QR code) associated with the saving card, which are displayed on one screen of the user equipment 100.

Further, the POS terminal 400 transmits to the payment server 500 the recognized (alternatively, checked) one or more of product/service information to be paid, the checked barcode (alternatively, the QR code) associated with the discount card, the checked barcode (alternatively, the QR code) associated with the saving card, the identification information on the POS terminal 400, the identification information on the user equipment 100, and the like.

As an example, the POS terminal 400 recognizes the barcode 910 for the corresponding AA discount card and the barcode 920 for the corresponding CC saving card displayed on one screen of the first user equipment illustrated in FIG. 9, respectively. Further, the POS terminal 400 transmits to the payment server 500 the recognized product information on the 11-th to 13-th products, the recognized barcode 910 for the corresponding AA discount card, the recognized barcode 920 for the corresponding CC saving card, the identification information of the POS terminal 400, the identification information of the first user equipment, and the like (S520).

Thereafter, the payment server 500 receives the one or more of product/service information to be paid, the barcode information (alternatively, the QR code information) associated with the discount card, the barcode information (alternatively, the QR code information) associated with the saving card, the identification information on the POS terminal 400, the identification information on the user equipment 100, and the like, which are transmitted from the POS terminal 400.

Further, the payment server 500 performs the payment function for the payment amount in which the discount amount corresponding to the discount card and the saving amount corresponding to the saving card are applied to the price information corresponding to one or more of product/service information to be paid, by interlocking with the user equipment 100, the service providing apparatus 300, and the POS terminal 400, based on the received barcode information (alternatively, the QR code information) associated with the discount card and the barcode information (alternatively, the QR code information) associated with the saving card.

As an example, the payment server 500 performs a payment function for a payment amount in which an amount (for example, 30,000 won−4,500 won=25,500 won) applying a discount amount (for example, 4,500 won which is 15% discount) corresponding to the AA discount card (alternatively, barcode information corresponding to the AA discount card) and an amount (for example, 1,500 won which is 5% discount) applying a saving amount corresponding to the CC saving card (alternatively, barcode information for the CC credit card) are applied to price information (for example, 30,000 won) corresponding to the product information on the 11-th to 13-th products, by interlocking with the first user equipment, the service providing apparatus 300, and the POS terminal 400 based on the barcode information on the AA discount card (for example, when paying 30,000 won or more, 15% discount) and the barcode information on the CC saving card (for example, 5% saving) transmitted from the POS terminal 400 (S530).

Thereafter, the payment server 500 transmits the payment function performance result to the POS terminal 400, the service providing apparatus 300, and the like. Herein, the payment function performance result (alternatively, the payment information) includes a product name (alternatively, a service name), a product unique code (alternatively, a service unique code), a unit price, a volume, a discount amount, whether a coupon is applied, a saving amount, an amount, an actual payment amount (alternatively, a total payment amount), payment date and time information, a payment card type (for example, a discount card used for payment, a credit card used for payment, etc.), and the like.

As an example, the payment server 500 transmits the payment function performance result for the 11-th to 13-th products to the POS terminal 400, the service providing apparatus 300, and the like (S540).

Thereafter, the POS terminal 400 receives the payment function performance result transmitted form the payment server 500.

Further, the POS terminal 400 transmits the received payment function performance result to the user equipment 100.

As an example, the POS terminal 400 transmits the received payment function performance result for the 11-th to 13-th products to the user equipment 100.

Further, the POS terminal 400 may output the received payment function performance result through a printed matter such as a receipt and the like (S550).

Thereafter, the user equipment 100 receives the payment function performance result transmitted from the POS terminal 400.

Further, the user equipment 100 displays the received payment function performance result.

As an example, the user equipment 100 receives the payment function performance result for the 11-th to 13-th products transmitted from the POS terminal 400. Further, the user equipment 100 displays the corresponding payment function performance result through an electronic wallet app (S560).

Thereafter, when the user having the corresponding user equipment 100 revisits the corresponding store later, the user equipment 100 transmits the unique identification information of the beacon 200 transmitted from the beacon 200, the identification information of the user equipment 100, and the like, to the service providing apparatus 300 (S570).

Thereafter, the service providing apparatus 300 receives the unique identification information of the beacon 200, the identification information of the user equipment 100, and the like, which are transmitted from the user equipment 100 revisiting the store which has been visited earlier.

Further, the service providing apparatus 300 checks store information corresponding to the received unique identification information of the beacon 200 in the store information for each unique identification information of a plurality of beacons stored in advance.

Further, the service providing apparatus 300 checks one or more of advertising information, one or more of benefit information, and the like which can be provided to the corresponding user equipment 100 in the store provided with the corresponding beacon 200 in a plurality of advertising information and a plurality of benefit information stored in advance based on the unique identification information of the corresponding beacon 200 and the identification information of the user equipment which are received above.

Further, the service providing apparatus 300 checks the checked store information and the received combination information of the discount card and the saving card corresponding to the identification information of the corresponding user equipment 100 in a plurality of store information pre-registered (or stored) and the combination information of the discount card and the saving card for each identification information of the user equipment.

Further, the service providing apparatus 300 performs a step (for example, S450) of transmitting the checked store information, the checked combination information of the discount card and the saving card, one or more of advertising information and one or more of benefit information which can be provided in the corresponding user equipment 100 in the store provided with the corresponding beacon 200, and the like, to the user equipment 100 (S580).

The user equipment, the service providing apparatus, the POS terminal, and the payment system including the same in some forms of the present disclosure can be prepared by a computer program and codes and code segments configuring the computer program may be easily deduced by a computer programmer in the art. Further, the corresponding computer program is stored in a non-transitory computer readable storage medium, and read and executed by the computer or the user equipment, the beacon, the service providing apparatus, the POS terminal, the payment server, and the like in some forms of the present disclosure to embody the user equipment, the service providing apparatus, the POS terminal, and the payment system including the same.

The non-transitory computer readable storage medium includes a magnetic storage medium, an optical storage medium, and a carrier wave medium. The computer program embodying the user equipment, the service providing apparatus, the POS terminal, and the payment system including the same in some forms of the present disclosure may be stored and installed in embedded memories of the wireless charging equipment, the terminal (alternatively, the user equipment) including the user equipment, the service providing apparatus, the POS terminal, the payment server, and the like. Alternatively, external memories such as a smart card storing and installing the computer program embodying the user equipment, the service providing apparatus, the POS terminal, and the payment system including the same in some forms of the present disclosure may be installed on the user equipment, the service providing apparatus, the POS terminal, the payment server, and the like through an interface.

In some forms of the present disclosure, as described above, when a user of the user equipment is positioned at a specific store by using a short-range communication scheme such as BLE, in the case of providing information on discount cards and saving cards usable in the corresponding store and selecting one discount card and one saving card among them, the selected discount card and saving card are displayed on one screen in a dual barcode form to perform simply application of the discount function according to a discount card and easily application of a saving function according to a saving card in the POS terminal. Thus, it is possible to improve convenience of the user and enhance satisfaction of the user according to payment.

Further, in some forms of the present disclosure, as described above, while the combination information of the discount card and the saving card for each store of the user equipment is stored in advance in the service providing apparatus, when the user equipment requests the store information on the specific store, the combination information of the discount card and the saving card stored in advance may be provided to the corresponding user equipment in association with the corresponding store in addition to the corresponding store information. Thus, it is possible to improve operating efficiency of the payment system and improve convenience of the user.

Hereinabove, although some forms of the present disclosure are described by specific matters such as concrete components, and the like, forms, and drawings, they are provided only for assisting in the entire understanding of the present disclosure. Therefore, the present disclosure is not limited to the forms. Therefore, some forms disclosed in the present disclosure are used to not limit but describe the technical spirit of the present disclosure and the scope of the technical spirit of the present disclosure is not limited by the forms. The scope of the present disclosure should be interpreted by the appended claims and all technical spirit in the equivalent range thereto should be interpreted to be embraced by the claims of the present disclosure.

According to some forms of the present disclosure, when a user of the user equipment is positioned at a specific store by using a short-range communication scheme such as BLE, in the case of providing information on discount cards and saving cards usable in the corresponding store and selecting one discount card and one saving card among them, the selected discount card and saving card are displayed on one screen in a dual barcode form to perform simply application of the discount function according to a discount card and easily application of a saving function according to a saving card in the POS terminal. Thus, the present disclosure can be widely used in a payment field, an advertising field, a service providing device field, a user equipment field, a POS terminal field which can improve convenience of the user and enhance satisfaction of the user according to payment.

What is claimed is:

1. A user equipment comprising:
a user equipment communication system configured to:
receive unique identification information of a beacon transmitted from the beacon,
transmit the received unique identification information of the beacon and identification information of the user equipment to a service providing apparatus, and
receive store information of a store, one or more of advertising information, one or more of benefit information and a list of recommended cards which are transmitted from the service providing apparatus in response to the transmitted unique identification information of the beacon and the identification information of the user equipment;
a user equipment display system configured to display the received store information, the one or more of advertising information, the one or more of benefit information, and the list of the recommended cards; and
a user equipment controller configured to:
check one discount card and one saving card selected from the list of the recommended cards displayed on the user equipment display system according to a user's selection, and
control the user equipment display system to simultaneously display a barcode or a QR code associated with the checked discount card and a barcode or a QR code associated with the checked saving card on one screen.

2. The user equipment of claim 1, wherein the user equipment communication system is further configured to transmit combination information of the checked discount card and the saving card according to the user's selection, the store information, and the identification information of the user equipment to the service providing apparatus.

3. The user equipment of claim 1, wherein the user equipment controller is further configured to perform a payment function for a payment amount in which a discount amount corresponding to the discount card and a saving amount corresponding to the saving card are applied to price information corresponding to one or more of product information to be paid or service information to be paid, by interlocking with the user equipment, the POS terminal, the service providing apparatus, and the payment server based on information on the barcode or the QR code associated with the discount card and information on the barcode or the QR code associated with the saving card recognized by the POS terminal, the one or more of product information to be paid or the service information to be paid being scanned or checked by the POS terminal.

4. The user equipment of claim 3, wherein the user equipment communication system is further configured to receive a payment function performance result transmitted from the payment server via the POS terminal,
wherein the user equipment display system is further configured to display the received payment function performance result, and
wherein the payment function performance result includes at least one of a product name, a service name, a product unique code, a service unique code, a unit price, a volume, a discount amount, whether a coupon is applied, a saving amount, an actual payment amount, payment date and time information, a type of the discount card used for payment, or a type of the saving card used for payment.

5. A user equipment comprising:
a user equipment communication system configured to:
receive unique identification information of a beacon transmitted from the beacon,
transmit the received unique identification information of the beacon and identification information of the user equipment to a service providing apparatus, and
receive store information of a store, combination information of a discount card and a saving card, one or more of advertising information, and one or more of benefit information, which are transmitted from the service providing apparatus in response to the transmitted unique identification information of the beacon and the identification information of the user equipment;
a user equipment display system configured to display the received store information, the one or more of advertising information, and the one or more of benefit information; and
a user equipment controller configured to control the user equipment display system to simultaneously display a barcode or a QR code associated with the discount card and a barcode or a QR code associated with the saving card on one screen based on the received combination information of the discount card and the saving card, in order to perform the payment function for one or more of product information or service information to be paid selected by a user of the user equipment.

6. A control method of a user equipment, the method comprising:
receiving, by a user equipment communication system, unique identification information of a beacon transmitted from the beacon;
transmitting, by the user equipment communication system, the received unique identification information of the beacon and identification information of the user equipment to a service providing apparatus;
receiving, by the user equipment communication system, store information of a store, one or more of advertising information, one or more of benefit information, and a list of recommended cards which are transmitted from the service providing apparatus in response to the transmitted unique identification information of the beacon and the identification information of the user equipment;
displaying, by a user equipment display system, the received store information, the one or more of advertising information, the one or more of benefit information, and the list of the recommended cards;
checking, by a user equipment controller, one discount card and one saving card selected from the list of the recommended cards displayed on the user equipment display system according to a user's selection; and
displaying, by the user equipment display system, a barcode or a QR code associated with the checked discount card and a barcode or a QR code associated with the checked saving card simultaneously on one screen.

7. The method of claim 6, wherein the method further comprises:
transmitting, by the user equipment communication system, combination information of the checked discount card and the checked saving card according to the user's selection, the store information and the identification information of the user equipment to the service providing apparatus, in order for management of the combination information of the checked discount card and the checked saving card according to the user's selection.

8. The method of claim 6, wherein the method further comprises:
performing, by the user equipment controller, a payment function for a payment amount in which a discount amount corresponding to the discount card and a saving amount corresponding to the saving card are applied to price information corresponding to one or more of product information to be paid or service information to be paid, by interlocking with the user equipment, the POS terminal, the service providing apparatus, and the payment server based on information on the barcode or the QR code associated with the discount card and information on the barcode or the QR code associated with the saving card recognized by the POS terminal, the one or more of product information to be paid or service information to be paid being scanned or checked by the POS terminal;
receiving, by the user equipment communication system, a payment function performance result transmitted from the payment server through the POS terminal; and
displaying, by the user equipment display system, the received payment function performance result.

9. A non-transitory computer-readable storage medium storing a computer program comprising a set of instructions that, when executed by a processor of a computing device, causes the processor to:
receive, through a network interface, unique identification information of a beacon transmitted from the beacon;
transmit, through the network interface, the received unique identification information of the beacon and identification information of the user equipment to a service providing apparatus;
receive, through the network interface, store information of a store, one or more of advertising information, one or more of benefit information, and a list of recommended cards which are transmitted from the service providing apparatus in response to the transmitted unique identification information of the beacon and the identification information of the user equipment;
display, on a display screen, the received store information, the one or more of advertising information, the one or more of benefit information, and the list of the recommended cards;
check one discount card and one saving card selected from the list of the recommended cards displayed on the user equipment display system according to a user's selection; and
display, on the display screen, a barcode or a QR code associated with the checked discount card and a barcode or a QR code associated with the checked saving card simultaneously on one screen.

10. A payment system comprising:
a service providing apparatus configured to:
receive unique identification information of a beacon transmitted from a user equipment and identification information of the user equipment,
check store information corresponding to the received unique identification information of the beacon from stored store information for each unique identification information of a plurality of beacons,
check one or more of advertising information and one or more of benefit information which can be provided to the user equipment in the store provided with the beacon from a plurality of advertising information and a plurality of benefit information stored in advance,
check, when the checked store information and the combination information of the discount card and the saving card corresponding to the received identification information of the user equipment are not included in a plurality of pre-registered store information and the combination information of the discount card and the saving card for each identification information of the user equipment, one or more discount cards and one or more saving cards to which the benefit information is applicable among a plurality of payment cards issued to the user equipment based on the checked one or more of benefit information,
generate a list of recommended cards including the checked one or more discount cards and the checked one or more saving cards, and
transmit the checked store information, the generated list of recommended cards, the one or more of advertising information, and the one or more of benefit information to the user equipment; and
the user equipment configured to display the store information, the list of recommended cards, the one or more of advertising information, and the one or more of benefit information, which are transmitted from the service providing apparatus.

11. A non-transitory computer-readable storage medium storing a computer program comprising a set of instructions that, when executed by a processor of a computing device, causes the processor to:
transmit, through a network interface, combination information of the checked discount card and the checked saving card according to the user's selection, the store information and the identification information of the user equipment to the service providing apparatus, in order for management of the combination information of the checked discount card and the checked saving card according to the user's selection.

12. A non-transitory computer-readable storage medium storing a computer program comprising a set of instructions that, when executed by a processor of a computing device, causes the processor to:
perform a payment function for a payment amount in which a discount amount corresponding to the discount card and a saving amount corresponding to the saving card are applied to price information corresponding to one or more of product information to be paid or service information to be paid, by interlocking with the user equipment, the POS terminal, the service providing apparatus, and the payment server based on information on the barcode or the QR code associated with the discount card and information on the barcode or the QR code associated with the saving card recognized by the POS terminal, the one or more of product information to be paid or service information to be paid being scanned or checked by the POS terminal;
receive, through a network interface, a payment function performance result transmitted from the payment server through the POS terminal; and
display, on a display screen, the received payment function performance result.
